(19) United States
(12) Patent Application Publication
(10) Pub. No.: US 2003/0110673 A1
(43) Pub. Date: Jun. 19, 2003

(54) Public sign edge protector

(76) Inventor: Dimitrous D. Tomboris, York, PA (US)

Correspondence Address: DIMITROIS TOMBORIS, 1196 ROXTON ROAD, YORK, PA, 17403, US

(21) Appl. No.: 10/021,070

(22) Filed: Dec. 19, 2001

(51) Int. Cl. G09F 1/00

(52) U.S. Cl. 40/612

(57) ABSTRACT

A special material used to provide covering to the sharp edges of traffic and public signs.

### FIELD OF THE INVENTION

The invention relates to injuries caused to pedestrian and others by public and traffic signs in parking lots, roadways and other areas.

### BACKGROUND OF THE INVENTION

This invention may have many applications, however, for the purpose of illustration, this invention is focus on traffic and public signs placed along roadways, parking lots and other areas.

Today, most signs that are placed along roadways and parking areas are metallic in their nature, and their sharp edges are not protected. This unprotected edge is hazardous, and is the focus of the invention. Injuries to pedestrians and others from these signs are wide spread, including my son. In large city roadway and in parking areas, these signs are placed close to pedestrian areas, and are elevated as low as two feet above the finish pavement. At these heights, pedestrians are often injured when they make contact. When contact is made with pedestrian and signs, it is often the sharp edge of the sign that makes the contact, since, in most cases, the pedestrians are trying to move away from the sign.

This invention addresses the safety of such signs, and in so doing, help in the reduction of serious injuries to pedestrians and others in our public thoroughfare.

### BRIEF SUMMARY OF THE INVENTION

In accordance with the invention, there is provided an absorbent material that when it comes into contact with human skin or other areas, and while providing a wrapping around public or traffic sign edges, as shown in the drawings, while at walking or other speeds, will cause little or no fracture thereof. The material will be able to wrap around the edge of the signs, be luminous, and would not react with the material of the sign as to cause break down of the materials absorbent nature.

With material, form and application, public and traffic signs could provide a means to reduce serious injuries that are often associated.

Some of the advantages of the invention is that the preferred embodiment provides relative safety to pedestrians; existing signs can be upgraded at a low cost, signs become more visible, etc.

Still other advantages of the present invention will become apparent during the course of the full detail description taken in connection with the accompanying drawings, forming portions of this disclosure, and in witch drawings:

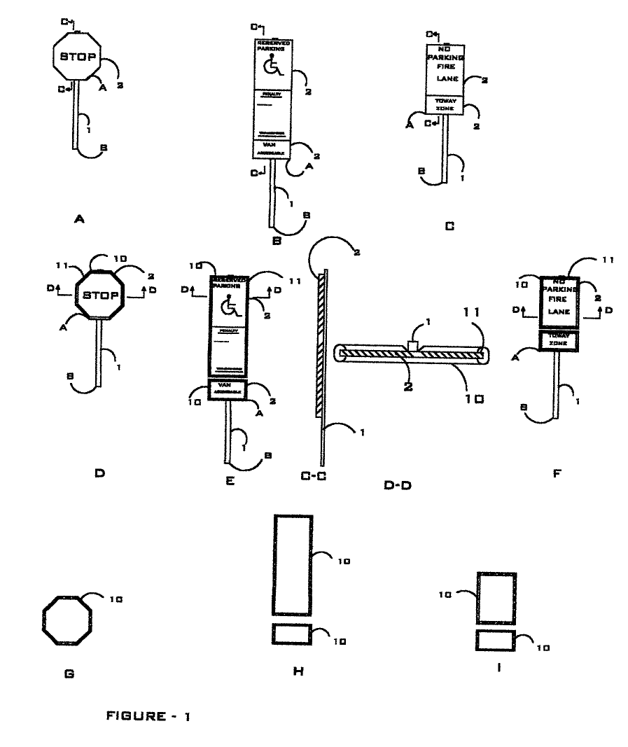

FIGS. 1. A,B & C Shows a sample of traffic and public signs referred to in the patent.

FIGS. 1. D,E & F shows the appearance of the sample signs as their are upgraded to the system of the invention,

FIGS. 1. G, H & I shows the various form and combination of the patent embodiment.

### DETAIL DESCRIPTION OF A PREFERRED EMBODIMENT OF THE INVENTION

With reference to FIGS. 1, A,B and C are typical of the sample of signs that are the focus of the invention. These signs consist of a vertical metallic support (1) and a metallic display area (2). The display area and the vertical support are coupled at a determine height from the finish pavement (AB). The system of the invention will provide a material suitable enough as to prevent serious injuries to pedestrians and others when they come into contact at walking velocities or other. The sample of the material form FIGS. 1, G,H & I (10), is to be manufactured having various form for specific sign dimensions, in a continuous loop G,H & I (10), and be installed along the sharp edge of the sign (2). In addition to the continuous loop (10), installation applications should include adhesive (11) on the surface area of the sign that comes into contact with the immaterial (10) covering the sharp edge (2). The material covering the sharp edges are to be treated as to provide luminous effect when strike by light rays.

Various changes could be made to the form of the invention herein shown and described, without departing from the true spirit of the scope of the invention or the scope of the claims.

What is claimed is:

1. A continuous covering around the sharp edges of traffic and public signs as shown in FIGS. 1, D,E and F, along with the installation application requirements described in the detail description.

2. Related forms as shown in the sampling in FIGS. 1, G,H & I (10), as is the manufacturing system of the invention.
